(19) United States
(12) Patent Application Publication
(10) Pub. No.: US 2024/0330995 A1
(43) Pub. Date: Oct. 3, 2024

(54) DATA DELIVERY SERVICES - VOLUME CONVERSION TO WORK UNITS

(71) Applicant: Schlumberger Technology Corporation, Sugar Land, TX (US)

(72) Inventors: Akshay Bapat, Pune (IN); Hemantkumar Prakashbhai Makhijani, Pune (IN); Vishvesh Paranjape, Pune (IN); Hemantkumar Prakashbhai Makhijani, Pune (IN); Jeremy Campbell, Yorkshire (GB); Anindya Mathur, Pune (IN); Stuti Pandey, New Delhi (IN); Nikita Rai, Pune (IN); Tasneem Jainuddin Khadkiwala, Pune (IN); Mehak Aggarwal, Pune (IN); Mohammad Arief Dharmawan, Pune (IN)

(21) Appl. No.: 18/715,024

(22) PCT Filed: Feb. 10, 2023
(86) PCT No.: PCT/US2023/012754

§ 371 Date: May 30, 2024

(30) Foreign Application Priority Data
Feb. 10, 2022 (IN) 202221007221

(51) Int. Cl. G06Q 30/0283; G06F 16/11; G06Q 30/04

(52) U.S. Cl. CPC G06Q 30/0283; G06F 16/116; G06Q 30/04

(57) ABSTRACT

Methods, systems, and computer-readable storage media are provided. A computing device crawls all files and formats for respective data types in a source data path for data to be uploaded or ingested. After the crawling, a number of data volumes of the data types are output. One or more destinations of the data are received by the computing device. A service request for approval including the source data path is received. The computing device converts the number of the data volumes to a number of units of work and estimates a cost of the service request. Approval of the service request by a representative of the requesting entity is received. A user works on the service request after the receiving of the approval of the service request. The service request is marked as resolved upon completion.

### CROSS-REFERENCE TO RELATED APPLICATIONS

This application claims the benefit of Indian patent application Ser. No. 20/222,1007221, entitled “Data Delivery Services-Volume Conversion to Work Units,” filed Feb. 10, 2022, the disclosure of which is incorporated herein by reference in its entirety.

### BACKGROUND

A data delivery services application may be configured to onboard source data and then manage the source data. The data delivery services application may further simulate standard subsurface workflows using a suite of applications or any industry standard artificial intelligence/machine learning technology.

The data delivery services application enables a customer to load raw data possessed by the customer into industry standard data management applications for further processes such as data interpretation, analytics, and assessments. This may assist the customer in performing dynamic analyses and making complex business decisions.

In one system, a customer is charged for data loading or ingestion services based on a number of man hours for manually loading or ingesting the data. In this system, data loading or ingestion is a manual process that could take, for example, 10 to 20 days or longer. In addition, because the data loading or the ingestion is performed manually by a human being, errors during the loading or the ingestion are not unusual.

### SUMMARY

Embodiments of the disclosure may provide a method for automatic data volume assessment and servicing of a service request. A computing device crawls files and formats for respective data types in a source data path after receiving, from a requesting entity, the source data path for data to be uploaded or ingested in respective targets, subfolders or files. The computing device outputs a number of data volumes of each of the data types after completing the crawling. The computing device receives one or more destinations for the data. A service request for approval is received by the computing device. The service request includes the source data path for the data to be uploaded or ingested in respective targets, the subfolders or the files. The computing device converts the number of the data volumes to a number of units of work after receiving the service request for approval, and automatically estimates a cost of the service request based on a defined unit price and the number of the units of work. The computing device receives approval of the service request, including the estimated cost, by a representative of the requesting entity. A user works on the service request using the computing device after the receiving of the approval of the service request from the representative of the requesting entity. The service request is marked as resolved upon completion of the service request.

In an embodiment, the method may include a second user encountering an issue with the service request and sending a message via the computing device to the requesting entity regarding finding a resolution to the issue. Examples of an issue may include a file in an unexpected or unsupported format, unable to find the source data path, etc.

In an embodiment, the method may include using, by the computing device, machine learning to learn file formats and data types of the requesting entity. For example, machine learning may learn file formats and data types used by each requesting entity. Thus, for example, when crawling files and formats for a requesting entity, machine learning may inform a process for crawling regarding file formats and data types to expect based on the machine learning.

In an embodiment, the method may include providing, by the computing device, progress notifications regarding the service request to the requesting entity.

In an embodiment, the method may include providing, by the computing device to the requesting entity, an estimate of the cost of the service, and providing, by the computing device to the requesting entity, an option to cancel the service request, reschedule the service request to later billing period, or place a service request on hold after providing the estimate of the cost of the service.

In an embodiment, the method may include receiving, by the computing device, a second service request for consulting services from a second user associated with a second requesting entity, the second service request including a level of expertise of a consultant and a time period for the consulting services. The computing device determines a second estimated cost of the consulting services based on the level of expertise and the time period. The computing device sends a second request for approval to a representative of the second requesting entity. The second request for approval includes the second estimated cost. The computing device receives approval of the second request for approval from the representative of the second requesting entity.

Responsive to the receiving of the approval of the second request for approval, the consultant is provided with the level of expertise for the time period of the consulting services.

Embodiments of the disclosure also provide a computing system for automatic data volume assessment and unit of work calculation. The computing system includes a processor, a bus, a network adapter connected with the processor via the bus, and a memory connected with the processor and the network adapter via the bus, wherein the memory includes instructions for the processor to perform operations. According to the operations, the computing device automatically crawls files and formats for respective data types in a source data path after receiving, from a user associated with the requesting entity, the source data path for data to be uploaded or ingested in respective targets, subfolders or files. A number of data volumes of each of the data types is output after completing the crawling. The computing device receives one or more destinations for the data. A service request for approval is received, wherein the service request includes the source data path for the data to be uploaded or ingested in the respective targets, the subfolders or the files. The number of the data volumes is converted to a number of units of work. A cost of the service request is estimated based on the defined unit price and the number of the units of work. The computing device receives approval of the service request by a representative of the requesting entity, wherein the service request includes the estimated cost. A user works on the service request after the receiving of the approval of the service request by the representative of the requesting entity. The service request is marked as resolved upon completion of the service request.

Embodiments of the disclosure may further provide a non-transitory computer-readable storage medium having instructions stored thereon for a computer to perform operations. According to the operations, the computer crawls files and formats for respective data types in a source data path after receiving, from a requesting entity, the source data path for data to be uploaded or ingested into respective targets, subfolders or files. A number of data volumes of each data type are output after completing the crawling. One or more destinations for the data are received. A service request for approval is received, wherein the service request includes source data path for the data to be uploaded or ingested in the respective targets, the subfolders or the files. The number of the data volumes are converted to a number of units of work. A cost of the service request is estimated based on a defined unit price and the number of units of work. An approval of the service request by a representative of the requesting entity is received. The service request includes the estimated cost. An user works on the service request after the receiving of the approval of the service request from the representative of the requesting entity. The service request is marked as resolved upon completion of the service request.

In this specification, the term, “target” is defined to include subfolders, files, and other data structures and the terms, “inloading” or “inloaded” are defined to refer to a data loading service or a data ingesting service.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example environment in which various embodiments may be implemented.

FIG. 3 illustrates an example progress notification that may be provided, according to an embodiment.

FIG. 4 is a flowchart of a process that may be performed in an embodiment in which billing is based on units of work.

FIG. 5 is a flowchart of a process that may be performed in an embodiment in which consulting services may be provided.

FIG. 6 is a flowchart of a process that may be performed in an embodiment in which quality assessment services may be provided.

FIG. 7 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

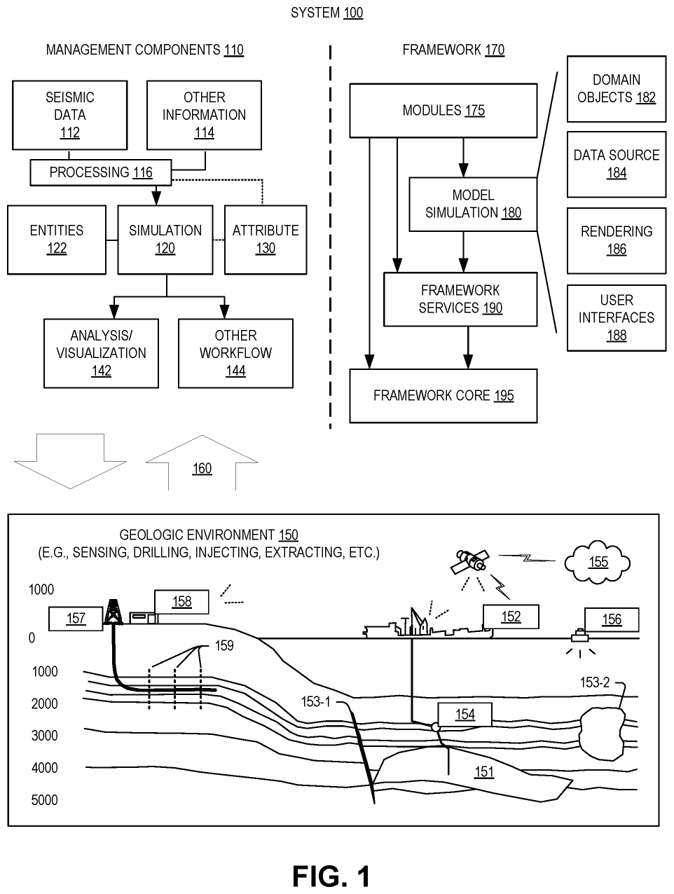

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 118, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEANR framework environment (Schlumberger Limited, Houston, Texas) allows for integration of add-ons (or plug-ins) into a PETREL® framework workflow. The OCEAN® framework environment leverages.NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

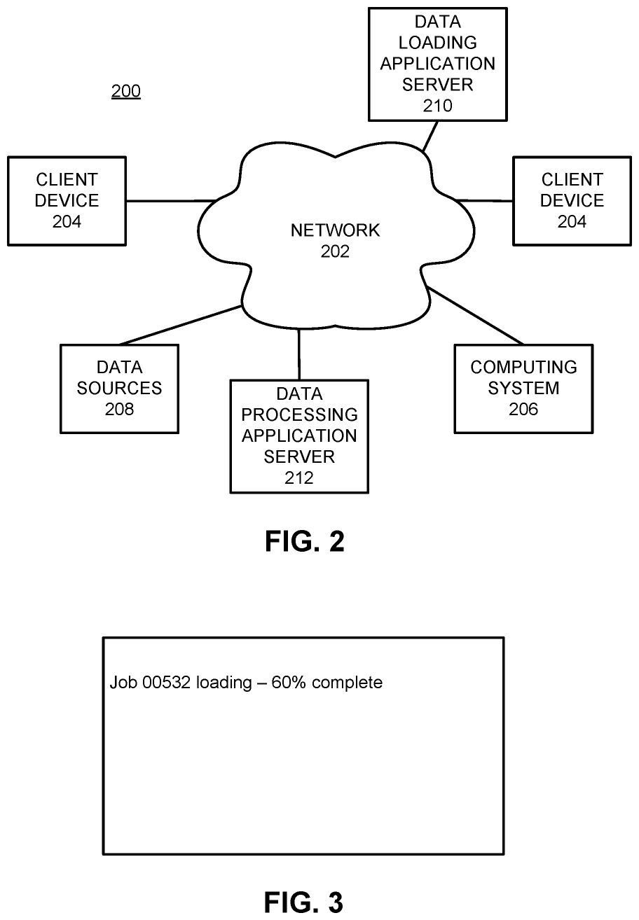

FIG. 2 illustrates an example petrotechnical processing environment 200 in accordance with aspects of the present disclosure. As shown in FIG. 2, environment 200 may include one or more client devices 204, which correspond to portable computing devices (e.g., laptops or a tablet computers), desktop computers, server computers and/or another type of computing device. In some embodiments, client devices 204 may be used to access the data loading application hosted by data loading application server 210 to request the data loading service from data loading application server 210 (e.g., a request to load data from one more data sources 208 to a database, repository, and/or application. Additionally, or alternatively, client devices 204 may be used to execute an application hosted by data processing application server 212. In some embodiments, client devices 204 may be used to access the data loading application hosted by data loading application server 210 to monitor and/or track the progress data loading requests via progress notifications. In some embodiments, data loading application may provide progress notifications to computing system 206, which may further provide progress notifications to appropriate users at client devices 204 via a user interface, email, text messages, audio messages and other means. FIG. 3 shows a progress notification that may be displayed by client device 204 via a user interface. The progress notification may provide a job ID along with an indication of how complete the job is. Similar messages may be provided via email, text messages, audio messages and other means.

Data loading application server 210 may include one or more computing devices that hosts a data loading application and processes data loading requests received from one or more users.

A data processing application server 212 may include one or more computing devices that host an application and may use or consume data loading from one or more data sources 208. As one illustrative example, data loading application server 210 may host a petrotechnical application to consume 2D seismic data, 3D seismic data, well-related data, etc. loaded from data sources 208 as part of a data loading request. Additionally, or alternatively, data processing application server 212 may host any other variety of application that consumes data loaded from data sources 208 as part of the data loading request.

A network 202 may include network nodes and one or more wired and/or wireless networks. For example, network 202 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, and evolution-data optimized (EVDO) network, or the like), a public land mobile network (PLMN), and/or another network. Additionally, or alternatively, network 202 may include a local area network (LAN), a wide area network (WAN), a metropolitan network (MAN), a public switched telephone network (PSTN), an ad hoc network, a managed Internet Protocol (IP) network, a virtual private network (VPN), an intranet, the Internet, a fiber optic-based network, and/or a combination of these or other types of networks. In various embodiments, network 202 may include copper transmission cables, optical transmission fibers, wireless transmission, routers, firewalls, switches, gateway computers and/or edge servers.

Environment 200 may include additional devices and/or networks; fewer devices and/or networks; different devices and/or networks; or differently arranged devices and/or networks than illustrated in FIG. 2. In some implementations, one or more devices of environment 200 may perform one or more functions described as being performed by another one or more of the devices of environment 200. Devices of environment 200 may interconnect wired connections, wireless connections, or a combination of the wired and the wireless connections.

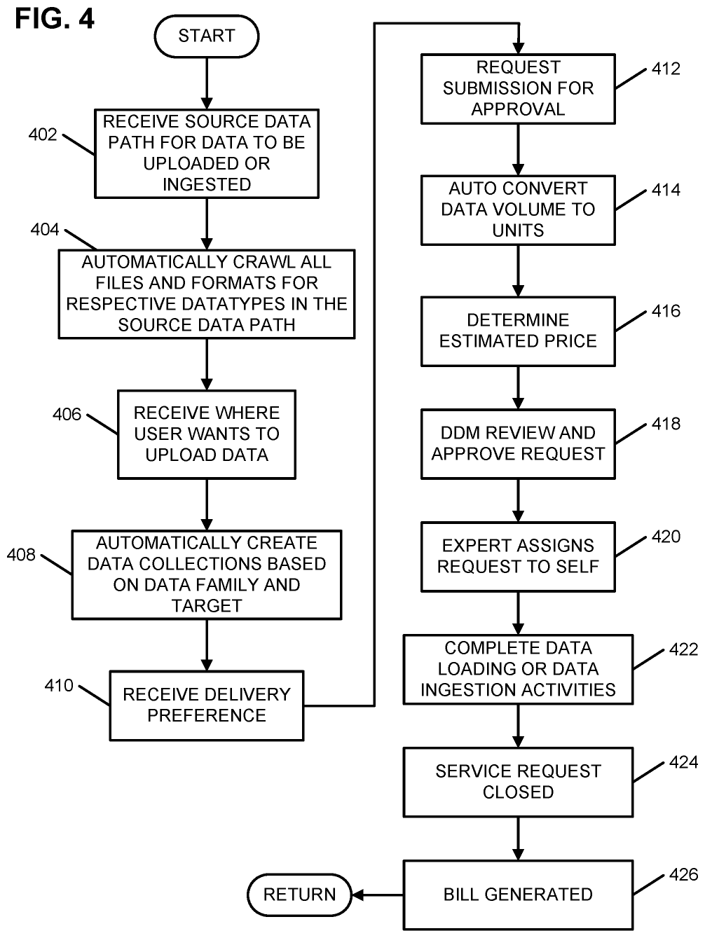

FIG. 4 illustrates a flowchart of a process for processing a request to access a data loading or ingesting service, according to an embodiment. As shown in FIG. 4, computing system 206 may receive from a user of an entity, via client device 204, a source data path for data in network storage to be uploaded or ingested (act 402). Computing system 206 may automatically crawl multiple files and formats for respective data types in the given source data path and may output numbers of data volumes of data such as, for example, well headers, deviations, checkshots, markers, log curves, 2D seismic, 2D navigations, 3D seismic, 3D survey grid, 2D horizon, 3D horizon, faults, fault boundary, surface grids, and documents (act 404).

Next, computing system 206 may receive from the user, via client device 204, an indication of a target area where the user wants to upload or ingest the data (act 406). Computing system 206 may automatically create data collections based on a data family and a target (act 408). For example, all data destined for a particular target may be included in a data collection, or all data of a particular type for a particular target may be included in a particular data collection.

Next, computing system 206 may receive from the user of client device 204, a delivery preference (act 410). One illustration for setting a Delivery Preference is as below: When an end user submits a data loading request for Seismic Data to be loaded, the end user may choose from the priority preference below:

### 1) Request to be Treated as NORMAL Request:

This means that the given request will be in a normal queue of requests which would be addressed as and when the queue of the requests is cleared by Data Loading experts.

### OR

### 2) Request to be Treated as PRIORITY Request:

This means that the given request will be in the priority queue and will be served on priority over the normal request queue. The delivery of this request would be expedited.

The delivery preference selected by the end user is sent as a part of a quote to the authorized approver of the requesting entity and needs to be approved prior to the assignment of the request to an expert.

After a final review, the user may, via client device 204, request submission for approval from a representative of the requesting entity (e.g., the authorized approver of the requesting entity), which may be received by computing system 206 (act 412). Upon receipt of the request, computing system 206 may automatically convert the data volumes to units of work (act 414). The units of work may be calculated, in some embodiments, according to Table 1.

TABLE 1
Conversion to work units

| | | 1 WORK UNIT | 1 WORK UNIT |
|---|---|---|---|
| | | CONVERSION- | CONVERSION- |
| DATA FAMILY | DATA TYPES | DATA LOADING | DATA INGESTION |
| Well Data | Well Header | Per 10,000 wells | Per 2,000 wells |
| Well Data | Deviation | Per 1,000 deviations | Per 1,000 deviations |
| Well Data | Checkshot | Per 1,000 Checkshots | Not Applicable |
| Well Data | Markers | Per 10,000 Markers | Per 5,000 Markers |
| Well Data | Log Curves | Per 1,000 log curves | Per 1,000 log curves |
| Seismic | 2D Seismic | Per 100 Lines \| Per 100 GB | Per 100 GB |
| Seismic | 3D Seismic | Per 50 Volumes \| Per 100 GB | Per 100 GB |
| Seismic | 2D Navigation | Included in 2D Seismic | Included in 2D Seismic |
| Seismic | 3D Survey Grid | Included in 3D Seismic | Included in 3D Seismic |
| Interpretation | 2D Horizon | Per 500 Horizons | Not Applicable |
| Interpretation | 3D Horizon | Per 500 Horizons | Not Applicable |
| Interpretation | Faults | Per 1,000 Fault files | Not Applicable |
| Interpretation | Fault Boundary | Per 1,000 Fault Boundaries | Not Applicable |
| Other | Other | Not Applicable | Not Applicable |

An estimated price may be determined or calculated based on a number of units of work and a defined unit price (act 416).

A service ticket may be created by computing system 206 and may include calculated units, a defined unit price, a total estimated price, and a service requested, and the service ticket may be sent for approval to a data delivery manager of the entity of the user. The request may be presented to the data delivery manager via a user interface, an email, a text message, an audio announcement, or via other means. The data delivery manager may review and approve the request, which is sent to computing system 206 via client device 204 of the data delivery manager (act 418).

Alternatively, if the data delivery manager does not approve the request, he or she may be provided with an option to cancel the service request, reschedule the service request to a later billing period, or place the service request on hold.

After the request is approved, an expert assigns the request to himself or herself (act 420). The expert may perform and complete data loading or data ingestion activities, as requested (act 422) and the service request then may be closed (act 424).

After the service request is closed, a bill for the entity may be generated (act 326).

FIG. 4 shows an example method only. In other embodiments, a method including fewer or additional steps may be used. For example, steps such as receiving one or more destinations for data, receiving a service request for approval, receiving approval of a service request by a representative of a requesting entity, working on the service request after the receiving of the approval of the service request, and marking the service request as resolved upon completion of the service request are examples of steps that may not be necessary in other embodiments.

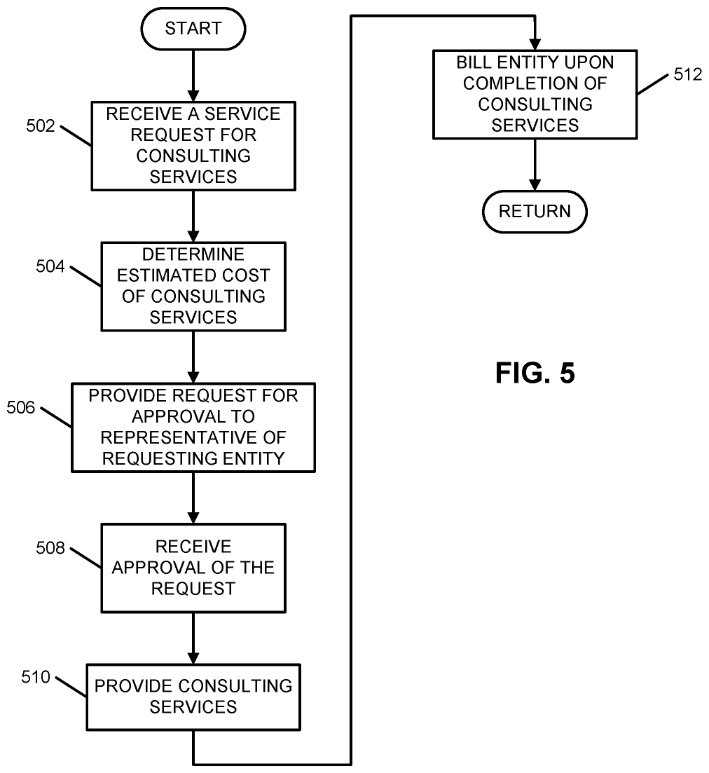

Although computing system 206 can be used to request data loading or data ingestion, it can be used to request other services as well. FIG. 5 is a flowchart showing an example process regarding consulting services. The process may begin with computing system 206 receiving a request for consulting services (act 502). The request may be received from client device 204 and may include a desired level of expertise of a consultant, dates for which the consultant services are requested, and an estimated number of hours of consulting services requested.

Next, computing system 206 may determine an estimated cost of the consulting services based on the estimated number of hours of consulting services requested and an hourly price for the consulting services at the requested level of expertise (act 504). A request for approval may be provided to a representative of the requesting entity (act 506). The request for approval may include a total estimated cost, a cost per hour, a level of expertise, estimated dates of service, and an estimated number of hours of service. The estimated cost may be provided to the representative via client device 204 of the representative via a user interface, email, text message, audio message, or via other means.

Upon receiving the request for approval, the representative may review and approve the request, via client device 204, which may be provided to computing system 206 (act 508). Next, the consulting services may be provided by a consultant having the requested level of expertise on the requested dates (act 510).

Upon completion of the consulting services, the requesting entity may be automatically billed (act 512).

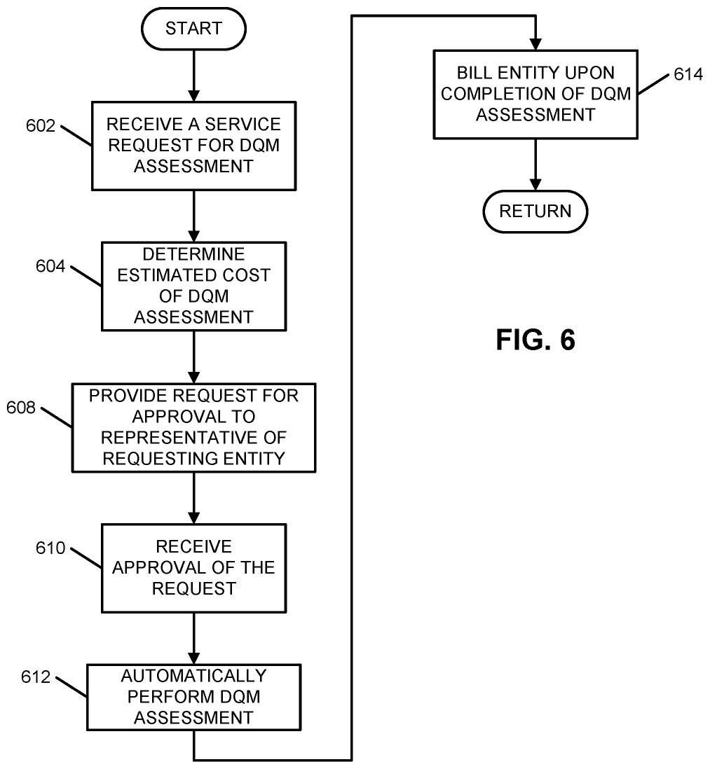

FIG. 6 is a flowchart of another example process in which a data quality management service request is received by computing system 206 (act 602). The data quality management service request may include a source data path of the data whose quality is to be checked. Computing system 206 then may determine an estimated cost of the data quality management review (act 604). This is accomplished by crawling through the data to determine a volume of the data, which then may be converted to units of work. A request for approval may be provided by computing system 206 to client device 204 of a representative of the requesting entity (act 608).

The request may be provided via a user interface, email, text message, audio message or via other means. The representative may review and approve the request, which may be received by computing system 206 (act 610).

Upon receiving the approval from the representative, computing system 206 may automatically perform data quality management assessment by crawling through the data and examining formats and values to determine validity of the data (act 612).

Upon completion of the data quality management assessment, the requesting entity may be automatically billed (act 614).

Table 2 shows file extensions and formats of data based on data family and data type.

TABLE 2
Data Families and Data Types

| | | DATA SOURCE |
|---|---|---|
| DATA FAMILY | DATA TYPES | File Extensions And Formats |
| Well data | Well Headers | ASCII (txt, csv, dat) |
| Well data | Deviations | ASCII (txt, csv, dat) |
| Well data | Checkshot | ASCII (txt, csv, dat) |
| Well data | Markers | ASCII (txt, csv, dat) |
| Well data | Log Curves | LIS, DLIS, LAS |
| Seismic data | 2D Seismic | SEGY, SGY |
| Seismic data | 2D Navigation | ASCII (txt, csv, dat) |
| Seismic data | 3D Seismic | SEGY, SGY |
| Seismic data | 3D Survey Grid | ASCII (txt, csv, dat) |
| Interpretation data | 2D Horizon | ASCII (txt, csv, dat) |
| Interpretation data | 3D Horizon | ASCII (txt, csv, dat) |
| Interpretation data | Faults | ASCII (txt, csv, dat) |
| Interpretation data | Fault Boundary | ASCII (txt, csv, dat) |

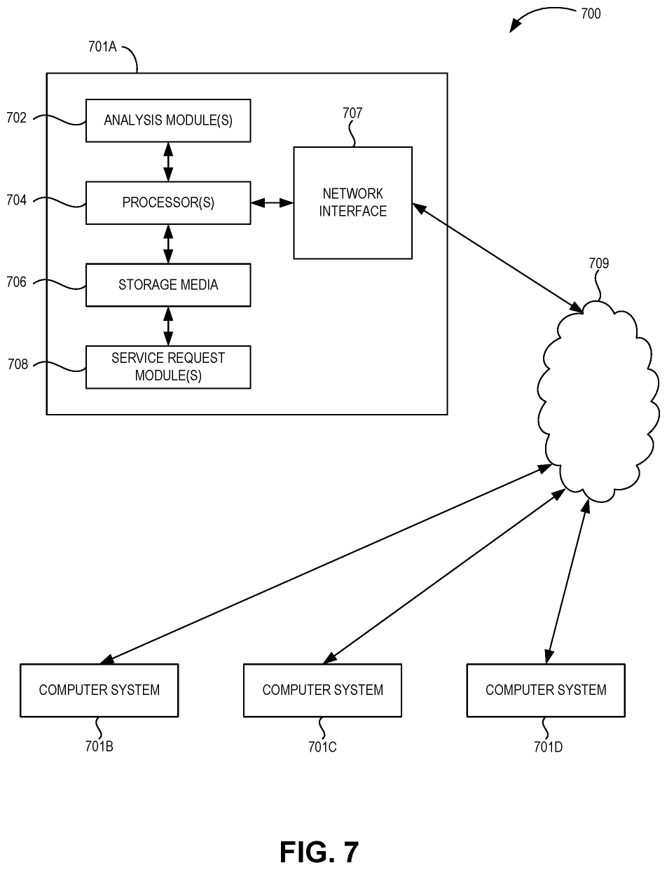

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more service request module(s) 708. In the example of computing system 700, computer system 701A includes the service request module(s) 708. In some embodiments, a single service request module may be used to perform some aspects of one or more embodiments of the methods disclosed herein. In other embodiments, a plurality of service request modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for automatic data volume assessment and servicing of a service request, the method comprising:
crawling, by a computing device, files for respective data types in a source data path after receiving, from a requesting entity, the source data path for data to be inloaded in respective targets;
outputting, by the computing device, a number of data volumes of each of a plurality of data types after completing the crawling;
receiving, by the computing device, one or more destinations for the data;
receiving, by the computing device, a service request for approval, the service request including the source data path for the data to be inloaded in the respective targets;
converting, by the computing device, the number of the data volumes to a number of units of work after receiving the service request for approval;
estimating, by the computing device, a cost of the service request based on a defined unit price and the number of the units of work;
receiving, by the computing device, approval of the service request by a representative of the requesting entity, the service request including the estimated cost;
working on the service request, by a user using the computing device, after the receiving of the approval of the service request from the representative of the requesting entity; and
marking the service request as resolved upon completion of the service request.

2. The method of claim 1, further comprising:
encountering, by the user, an issue with the service request;
sending a message via the computing device to the requesting entity regarding finding a resolution to the issue.

3. The method of claim 1, further comprising:
using, by the computing device, machine learning to learn file formats and data types of the requesting entity.

4. The method of claim 1, further comprising:
providing, by the computing device, progress notifications regarding the service request to the requesting entity.

5. The method of claim 1, further comprising:
providing, to the requesting entity, an estimate of the cost of the service; and
providing, to the requesting entity, an option to cancel the service request, reschedule the service request to a later billing period, or place the service request on hold after providing the estimate of the cost of the service.

6. The method of claim 1, further comprising:
receiving, by the computing device, a second service request for consulting services from a second user associated with a second requesting entity, the second service request including a level of expertise of a consultant and a time period for the consulting services;
determining, by the computing device, a second estimated cost of the consulting services based on the level of expertise and the time period;
providing, by the computing device, a second request for approval to a representative of the second requesting entity, the second request for approval, including the second estimated cost;
receiving, by the computing device, approval of the second request for approval from the representative of the second requesting entity; and
responsive to the receiving of the approval of the second request for approval, providing the consultant with the level of expertise for the time period of the consulting services.

7. The method of claim 6, further comprising:
providing a bill, by the computing device, for the consulting services upon completion of the consulting services.

8. A computing system for automatic data volume assessment and unit of work calculation, the computing system comprising:
a processor;
a bus
a network adapter connected with the processor via the bus;
a memory connected with the processor and the network adapter via the bus, the memory including instructions for the processor to perform a plurality of operations comprising:
crawling files for respective data types in a source data path after receiving, from a user associated with a requesting entity, the source data path for data to be inloaded in respective targets;
outputting a number of data volumes of each of a plurality of data types after completing the crawling;
receiving one or more destinations for the data;
receiving a service request for approval, the service request including the source data path for the data to be inloaded in the respective targets;
converting the number of the data volumes to a number of units of work;
estimating a cost of the service request based on a defined unit price and the number of the units of work;
receiving approval of the service request by a representative of the requesting entity, the service request including the estimated cost;
working on the service request, by a user of the computing system, after the receiving of the approval of the service request by the representative of the requesting entity; and
marking the service request as resolved upon completion of the service request.

9. The computing system of claim 8, wherein the plurality of operations further comprise:
in response to encountering an issue, sending a message to the requesting entity regarding finding a resolution to the issue.

10. The computing system of claim 8, wherein the plurality of operations further comprise:
using machine learning to learn file formats and data types of the requesting entity.

11. The computing system of claim 8, wherein the plurality of operations further comprise:
providing progress notifications regarding the service request to the requesting entity.

12. The computing system of claim 8, wherein the plurality of operations further comprise:
providing, to the requesting entity, an estimate of the cost of the service; and
providing, to the requesting entity, an option to cancel the service request, reschedule the service request to a later billing period, or place the service request on hold after providing the estimate of the cost of the service.

13. The computing system of claim 8, wherein the plurality of operations further comprise:
receiving a second service request for consulting services, the second service request including a level of expertise of a consultant and a time period for the consulting services;
determining a second estimated cost of the consulting services based on the level of expertise and the time period;
providing a second request for approval to a representative of the second requesting entity, the second request for approval, including the second estimated cost;
receiving approval of the second request for approval from the representative of the second requesting entity; and
responsive to the receiving of the approval of the second request for approval, providing the consultant with the level of expertise for the time period of the consulting services.

14. The computing system of claim 13, wherein the plurality of operations further comprise:
providing a bill for the consulting services upon completion of the consulting services.

15. A non-transitory computer-readable storage medium having instructions stored thereon for a computer to perform a plurality of operations, the plurality of operations comprising:
crawling files and formats for respective data types in a source data path after receiving, from a requesting entity, the source data path for data to be inloaded in respective targets;
outputting a number of data volumes of each of a plurality of data types after completing the crawling;
receiving one or more destinations for the data;
receiving a service request for approval, the service request including the source data path for the data to be inloaded in the respective targets;
converting the number of the data volumes to a number of units of work;
estimating a cost of the service request based on a defined unit price and the number of the units of work;
receiving approval of the service request by a representative of the requesting entity, the service request including the estimated cost;
working on the service request, by a user of the computer, after the receiving of the approval of the service request from the representative of the requesting entity; and
marking the service request as resolved upon completion of the service request.

16. The non-transitory computer-readable storage media of claim 15, wherein the plurality of operations further comprise:
in response to encountering an issue, sending a message to the requesting entity regarding finding a resolution to the issue.

17. The non-transitory computer-readable storage media of claim 15, wherein the plurality of operations further comprise:
providing progress notifications regarding the service request to the requesting entity.

18. The non-transitory computer-readable storage media of claim 15, wherein the plurality of operations further comprise:
providing, to the requesting entity, an estimate of the cost of the service; and
providing, to the requesting entity, an option to cancel the service request, reschedule the service request to a later billing period, or place the service request on hold after providing the estimate of the cost of the service.

19. The non-transitory computer-readable storage media of claim 15, wherein the plurality of operations further comprise:
receiving a second service request for consulting services, the second service request including a level of expertise of a consultant and a time period for the consulting services;
automatically determining a second estimated cost of the consulting services based on the level of expertise and the time period;
providing a second request for approval to a representative of the second requesting entity, the second request for approval, including the second estimated cost;
receiving approval of the second request for approval from the representative of the second requesting entity; and
responsive to the receiving of the approval of the second request for approval, providing the consultant with the level of expertise for the time period of the consulting services.

20. The non-transitory computer-readable storage media of claim 19, wherein the plurality of operations further comprise:
automatically providing a bill for the consulting services upon completion of the consulting services.
